(19) United States
(12) Patent Application Publication
(10) Pub. No.: US 2014/0279542 A1
(43) Pub. Date: Sep. 18, 2014

(54) MOBILE CURRENCY MESSAGING SYSTEMS

(71) Applicant: Independence Bancshares, Inc., Greenville, SC (US)

(72) Inventors: Gordon BAIRD, Darien, CT (US); Humphrey CHEN, Palisades Park, NJ (US); Aditya KHURJEKAR, Basking Ridge, NJ (US)

(73) Assignee: INDEPENDENCE BANCSHARES, INC., Greenville, SC (US)

(21) Appl. No.: 14/212,556

(22) Filed: Mar. 14, 2014

Related U.S. Application Data
(60) Provisional application No. 61/791,981, filed on Mar. 15, 2013.

(51) Int. Cl. G06Q 20/32; G06Q 20/40

(52) U.S. Cl. CPC G06Q 20/322; G06Q 20/40
USPC 705/44

(57) ABSTRACT

Exemplary embodiments provide methods, mediums, and systems for facilitating mobile transactions. For example, a routing system and protocol is provided to allow a user of a mobile financial application, which may be provided in a closed loop network, to connect to external entities located outside of the closed loop network. In some embodiments, requests to perform transactions may be aggregated and prioritized in order to perform load balancing among the request. In further embodiments, records related to the transactions may be purged after a predetermined period of time, subject to regulatory requirements, in order to protect the privacy of the user.

### RELATED APPLICATIONS

This application claims priority to U.S. Provisional Patent Application Ser. No. 61/791,981, entitled “Methods, Systems, and Mediums for Supporting Mobile Payments” and filed on Mar. 15, 2013. The contents of the aforementioned application are incorporated herein by reference

### BACKGROUND

Increasingly, consumers rely upon computer networks, such as the Internet, as well as mobile devices, to engage in commerce. In conjunction with this trend, there has been a rise in the electronic movement of funds, as well as the use of electronic forms of currency. This has resulted in a number of problems and opportunities.

Regarding the electronic movement of funds, numerous banks provide online services. Similarly, some online services have begun to provide electronic access to funds. Typically, these entities make use of proprietary back-ends which process information related to the accounts of customers associated with the entity. However, there is no commonly-accepted middleware that allows the different back-ends of disparate entities to communicate with each other. This issue may make it difficult to fluidly move currency between entities, and for different entities to communicate with each other regarding a customer.

Regarding electronic forms of currency, some online services (e.g., PayPal™) provide a way to receive and transfer currency online. Indeed, recently some currencies have been developed which are primarily for use in electronic form (e.g., BitCoin). However, these online services and electronic currencies suffer from limitations which may make it difficult for them to become widely adopted as a replacement for cash, credit cards, or other forms of currency. For example, these online services typically function similar to banks and therefore maintain records of transactions for a lengthy amount of time. Furthermore, some limitations of this form of service may prevent cash from being transferred from one entity to another quickly. This differs from a system such as a cash transaction, where trades of currency occur instantaneously and are generally not traceable. Some consumers would prefer the anonymity and speed of cash for convenience and due to privacy concerns, among other issues.

The present application addresses solutions to these and other problems of electronic commerce and currency.

### SUMMARY

According to exemplary embodiments, methods, mediums, and systems are provided for performing mobile currency transactions. For example, a routing system and protocol is provided to allow a user of a mobile financial application, which may be provided in a closed loop network, to connect to external entities located outside of the closed loop network. In some embodiments, requests to perform transactions may be aggregated and prioritized in order to perform load balancing among the request. In further embodiments, records related to the transactions may be purged after a predetermined period of time, subject to regulatory requirements, in order to protect the privacy of the user.

Using the exemplary embodiments described herein, different financial networks (including open-loop networks and closed-loop networks) may be capable of communicating with each other in order to carry out a wider range of financial transactions. Requests for transactions may be prioritized and balanced amongst each other. Furthermore, the purging of records allows financial systems to mimic the privacy of cash transactions while still maintaining the records necessary to ensure regulatory compliance.

According to an exemplary embodiment, a system may be provided for routing mobile transaction messages. The system may include a receiving interface for receiving a request to perform a mobile transaction from a requestor in a closed-loop network. The request may relate to an entity in an external network. The receiving interface may be connected to the closed-loop network and configured to receive transaction messages in a format compatible with the closed-loop network.

The system may further include a non-transitory electronic-device readable storage medium storing electronic instructions that, when executed by a processor of the system, cause the processor to perform process. The process may involve parsing the request to identify a type of the request. For example, the request may be related to a balance inquiry, a request to transfer funds (which may be in the form of an electronic currency), and a request for authentication. The request may be directed to an external entity, such as a bank account, a currency account, or another user of the system (which may be embodied, at least in part, as a mobile wallet application).

The process may further involve identifying further information needed to carry out requests of the identified type, and retrieve the identified further information from a financial institution or application.

The retrieved identified further information may be evaluated to determine whether the mobile transaction is permitted to proceed. Based on the evaluation, the system may generate instructions instructing an external network to carry out the request.

The system may further include a transmitting interface for transmitting the instructions. The transmitting interface may be connected to the external network and configured to transmit transaction messages in a format compatible with the external network.

In order to determine if the request is legitimate, the system may inspect a unique time stamped string associated with the request. The unique time stamped string may include one or more of a time stamp, identifying information related to a mobile device of the requestor, an identity of the requestor, location information identifying a location of the mobile device of the requestor, and a SIM identifier identifying a SIM card of the mobile device of the requestor.

Once the transaction is completed, the system may generate a record of the transaction at a mobile device of the requestor and/or at an entity involved in the transaction. The system may receive an instruction from the requestor not to store a receipt for the transaction.

In response to the instruction, the system may quarantine the transaction record, wait a predetermined period of time, and purge the record from the mobile device of the requestor and/or from the entity. The requestor's record and the entity's record may be purged at the same time, or may be purged at different times. The predetermined period of time(s) may be determined, at least in part, based on regulatory compliance requirements.

Alternatively, the system may determine that the transaction may not be eligible for purging, and may maintain a copy of the record (potentially in the quarantine).

In some embodiments, the system may perform load balancing. For example, the system may receive a plurality of requests associated with a plurality of transactions, and may determine that a subset of the plurality of requests are of a same type. The system may aggregate the subset of the plurality of requests, and may execute an aggregated transaction based on the plurality of transactions.

The subset of the plurality of requests may be assigned a priority based on one or more metrics, and the aggregated transaction may be executed based on the priority.

The plurality of requests may be carried out through an exchange. In order to facilitate a series of transactions that may be carried out with respect to a particular exchange, one or more entry or exit points into or out of the exchange may be generated.

The exemplary embodiments will be described in more detail with respect to the Figures discussed below.

### BRIEF DESCRIPTION OF THE DRAWINGS

FIG. 1 depicts a system for routing messages related to mobile transactions and/or electronic currencies according to an exemplary embodiment.

FIG. 2A depicts a flowchart describing a method for routing messages related to mobile transactions and/or an electronic currency according to an exemplary embodiment.

FIG. 2B depicts a flowchart describing an exemplary method for performing a secure handshake according to an exemplary embodiment.

FIG. 2C depicts an exemplary unique time stamped string (UTSS) suitable for use in the exemplary secure handshake depicted in FIG. 2

FIG. 3 depicts a flowchart describing a method for carrying out a mobile transaction and purging records related to the transaction according to an exemplary embodiment.

FIG. 4 depicts a flowchart describing a method for performing load balancing among mobile transaction messages according to an exemplary embodiment.

FIG. 5 depicts an electronic device suitable for use with exemplary embodiments described herein.

### DETAILED DESCRIPTION

### Terms and General Notes

Unless otherwise noted, the following terms are used herein with the following meanings:

A typical environment involving the transfer of electronic currency (e.g., for micropayments) includes a Sender, e.g. the entity that provides the value (money, currency, funds or other tangible units of value); a Receiver, e.g. the entity that receives the value; a Sending Agent, e.g. the entity that facilitates the sending of value on behalf of the Sender; a Receiving Agent, e.g. the entity that facilitates the receiving of value on behalf of the Receiver; the Provider, e.g. the administrator of the Exchange, which may be a clearinghouse, marketplace, aggregator or overall facilitator of such a service. The Provider is often expected to be an authorized financial institution.

As used herein, an Open Loop Network is a multi-party network that connects two or more financial institutions for carrying out financial transactions. Payments for goods and services in an open loop network are typically managed by the connected financial institutions (usually a first financial institution that issues credit to a customer, and a second financial institution that is associated with a merchant). Visa and MasterCard are examples of open loop networks. In contrast, a Closed Loop Network is a network in which payments are made directly by the owner of the network (e.g., a merchant that issues a private-label credit card to its customers, or a merchant that issues a specialized currency such as Disney Dollars).

As used herein, micropayments are financial transactions, usually of small value, between many distinct senders and receivers, and usually large in number and with a high frequency of occurrence.

As used herein, a currency may be a physical currency, a currency issued by a state entity, and/or a virtual currency such as BitCoin.

Also, as used herein, the article “a” is intended to include one or more items. Where only one item is intended, the term “a single” or similar language is used. Further, the phrase “based on,” as used herein is intended to mean “based, at least in part, on” unless explicitly stated otherwise. In addition, the term “user”, as used herein, is intended to be broadly interpreted to include, for example, an electronic device (e.g., a workstation) or a user of an electronic device, unless otherwise stated.

No element, act, or instruction used in the description of the invention should be construed critical or essential to the invention unless explicitly described as such. It is intended that the invention not be limited to the particular embodiments disclosed above, but that the invention will include any and all particular embodiments and equivalents falling within the scope of the description herein.

### Contextual Material

As noted above, exemplary embodiments described herein relate to mobile currencies. In some embodiments, these mobile currencies may be used in conjunction with mobile identities and authentication techniques—for example, in order to verify the identities of parties to a mobile transaction. Examples of mobile identities and authentication techniques are described in U.S. patent application Ser. No. ______ entitled Creation and Use of Mobile Identities (attorney docket no. IBW-002), filed Mar. 17, 2014. The contents of this application are incorporated herein by reference.

Furthermore, the mobile currencies and mobile transactions described herein may be carried out using a transaction system, routing protocols, and interfaces (such as Application Programming Interfaces, or “APIs”). Examples of such systems, protocols, and interfaces are described in U.S. patent application Ser. No. ______ entitled Methods and Systems for Executing Mobile Currency Transactions (attorney docket no. IBW-003), filed Mar. 17, 2014. The contents of this application are incorporated herein by reference.

### Exemplary Embodiments

Multiple wallet platforms exist around the world and will continue to be developed. Many have different underling architectures, code, and protocols, and accordingly cannot efficiently communicate with one another. According to one exemplary embodiment, methods and systems for electronically routing customer payment transactions are provided.

According to an exemplary embodiment, one or more centralized servers may be deployed. The centralized servers may interface with: a) multiple wallet platforms in multiple markets; b) multiple inter-bank payment networks; and c) multiple core processing systems. An Application Program Interface (API) may be provided for one or more entities with which the centralized servers interface. A database may be provided to serve as a switch that clears messages between the entities.

For example, FIG. 1 depicts an exemplary environment for carrying out electronic transactions, such as mobile and/or electronic currency transactions.

A user wishing to send or receive currency (or perform other actions, such as checking a balance in a currency account, checking the status of a transaction, etc.) may interact with a mobile financial application 110, such as a wallet application resident on a mobile device (e.g., a smartphone or tablet). The mobile financial application 110 may provide an interface, such as a graphical user interface, that allows the user to initiate a currency transaction. The mobile financial application 110 may include logic for formulating transaction request messages initiating a currency transaction.

The mobile financial application 110 may be associated with, and may communicate through, a closed loop network 120. The closed loop network 120 may be owned and/or administered by the provider of the mobile financial application 110.

The mobile financial application 110 may identify a message destination and a message source and may determine, according to pre-defined parameters, whether the message is eligible for processing via an internal entity (e.g., an entity associated with the closed loop network 120, which may be but is not necessarily a bank or e-commerce entity) or by an external entity (e.g., a bank or e-commerce entity not associated with the above-mentioned database).

Eligible messages may be routed, for example, to an internal database in the closed loop network 120, or may be routed to an Automated Clearing House (“ACH”) processor. Ineligible transactions may be routed to an external message network, such as a network affiliated with an external bank.

In some situations, the transaction request messages may be directed to an entity outside of the closed loop network 120. For example, the user of the mobile financial application may request currency from, or may request to send currency to, an individual or financial institution located outside of the closed loop network 120.

Thus, the closed loop network may be capable of being interfaced with connection logic 130 for connecting the closed loop network to external entities. Upon generating a transaction request message, the mobile financial application 110 may use the closed loop network 120 to transmit the request to the connection logic 130.

The connection logic 130 may establish a secure connection to the external entity. The connection logic 130 may, for example, perform a secure handshake with the external entity. The secure handshake may serve to authenticate the external entity to the connection logic (and, by extension, the user of the mobile financial application 110) and vice versa. An exemplary procedure for establishing a secure connection is described in detail in FIGS. 2A and 2B.

Once the secure connection has been established, routing and/or business logic 140 may be consulted to determine what to do with the message. An exemplary procedure preformed by the routing and business logic is described in detail in FIGS. 2A and 2C.

In order to perform and/or validate the transaction, the routing and business logic 140 may retrieve information from the mobile carrier 150 of the user of the mobile financial application 110. For example, in order to verify that the transaction is legitimate, the routing and business logic 140 may retrieve the home location register (HLR) and visitor location register (VLR) of the user's mobile device, and/or geographical location information. If the information retrieved from the mobile carrier 150 suggests that the transaction is illegitimate (e.g., a large transaction is originating at a location where the user has never been before), then the routing and business logic 140 may terminate the transaction and/or flag the transaction with a fraud alert.

The routing and business logic may interface with one or more external entities, such as an external financial network 160 and/or an external non-financial network 170. The external entity to which the transaction is directed may be present in the external network 160/170.

Examples of external financial networks include regulated financial networks, such as banks and private electronic funds transfer (EFT) organizations, ACHs, Federal Reserve Wire Network (FEDWire) participants, and the SWIFT International financial payment system. External financial networks further include private closed loop systems, which may alternatively be an example of an external non-financial network.

The entities depicted in FIG. 1 may, individually or together, perform a procedure for generating, routing, and processing an electronic transaction. An exemplary procedure is shown in FIGS. 2A-2C.

At step 210, a customer may access an application, which may be associated with a local market, on a local connection device. The application may be associated with, or may be, a mobile financial application such as a mobile wallet. The application may be associated with a “closed loop,” which represents an ecosystem of the mobile wallet administered by a developer or owner of the code for the mobile wallet application. The closed loop may include the local market, and may be (at least initially) inaccessible to entities located outside the closed loop (i.e., entities not associated with the mobile wallet application).

At step 212, the customer may submit a request to perform functionality of the mobile wallet, such as performing a mobile or electronic currency transaction. The request may be received by (for example) the connection logic 130.

The functionality may require connectivity to another system (e.g., a system in an external network 160/170). The other system may be initially disconnected from the closed loop. Accordingly, in order to provide functionality beyond what is available in the closed loop, the mobile wallet may need to communicate with another network 160/170 or piece of software.

Accordingly, in order to establish a secure connection between the device running the mobile wallet and the other system outside the closed loop, at step 214 a handshake may be performed between the device and the system. The handshake may be performed according to a protocol agreed to by the developer/owner of the closed loop and the other system. Communications according to the handshake protocol may be encrypted. An exemplary protocol for performing such a handshake is described in more detail below, in relation to FIG. 2B

Such a protocol may include parameters that may be processed in order to connect the device to the system. The parameters may include, for example, a personal identification number (PIN), information resident on the device running the mobile wallet, biometric information such as a voice print, and/or system information for the device running the mobile wallet. Multiple parameters may be used together. An example of a parameter useful for performing the secure handshake is a unique time stamped string (UTSS), which includes information on the time at which the transaction was initiated, and information identifying the requestor of the transaction. An exemplary UTSS is described in more detail with respect to FIG. 2C, below.

After performing the secure handshake, at step 216 messages may be passed from the mobile wallet device (e.g., a non bank currency system) to the external system.

At step 218, the messages may be parsed to identify key words or message identifiers. For example, the messages may include a header that identifies, among other items, to what type of transaction the message pertains. Alternatively or in addition, the message body may include keywords identifying the type of transaction.

At step 220, the external system may, on the basis of the parsing performed at step 218, determine what type of request is associated with the messages. Examples of such a request include an inquiry into an account balance, a request to move or transfer money, a request for authentication, etc.

At step 222, the external system may perform a predetermined process based on the type of request. The predetermined process may involve determining, based on the type of request, what information is required to carry out the request. For example, in order to check an account balance, the external system (which may be, e.g., a bank) may need to determine whether the user of the mobile financial application 110 is an account holder at the external system. The required information may be determined based on internal procedures governing the external system (e.g., standards put in place by a bank), or may be determined based on regulatory compliance (e.g., information that must be collected in order to comply with local, regional, national, or international laws).

At step 224, the external system may acquire the information identified at step 222. This may involve, for example, establishing a connection/request to another mobile wallet user. Alternatively, an inquiry may be made into a bank (or multiple banks) or currency account associated with the user of the original mobile wallet application.

If the external system is a bank or currency account, the inquiry may determine whether the original owner of the mobile wallet application is a current account holder at the bank or currency account. If so, information related to the account and/or account holder may be requested from the mobile financial application and/or the device running the mobile financial application. For example, the external system may request that the user of the mobile financial application provide the external system with the user's account number, a PIN, a user name, or a password.

At step 226, the external system may evaluate the information acquired at step 224 in order to determine whether to move forward with the request/transaction. For example, the external system may determine whether there is sufficient currency in the customer/account holder's account to complete the transaction.

Based on the evaluation at step 226, the system may determine, at step 228, whether to proceed with the transaction. For example, if the system determines that there is not sufficient currency in the user's account, the system may decide to terminate the transaction. If the decision at step 228 is “NO” (i.e., do not proceed with the transaction), then processing may proceed to step 230. At step 230, a termination message may be generated explaining why the transaction was aborted (e.g., insufficient funds), and may be sent to the user via the mobile financial application 110. Processing may then proceed to step 232 and end.

If, on the other hand, the system determines at step 228 that the transaction should proceed, the system may optionally confirm at step 234 whether the user wishes to proceed with the transaction. Step 234 may involve, for example, presenting the user with an interface via the mobile financial application that informs the user that the transaction has been approved and will be carried out upon the user's approval. If the user indicates approval (e.g., by pressing a “confirm” button in the application), then processing may proceed to step 236.

At step 236, the external system may generate and transmit a message to any involved local or third party systems to effect the transaction. Processing may then proceed to step 232 and end.

If, on the other hand the user does not approve the transaction at step 234, then processing may proceed to step 230, where a termination message (e.g., indicating that the transaction was aborted by the user) may be generated.

As noted above with respect to step 214, it may be necessary or desirable for communications between the closed loop network and the external system to be validated and secured. FIG. 2B depicts an exemplary procedure for establishing a secure connection in more detail.

In order to validate messages originating in the closed loop network 120, the closed loop network may assign an ID token to such messages. Any message without a valid ID token may be treated as falsified. This allows the closed loop network 120 to protect the integrity of users of the closed loop network by preventing outside entities from attempting to impersonate a user of the closed loop network.

Thus, at step 250, the connection logic may determine whether the message initiating the transaction includes an ID token from the closed loop network. The connection logic may attempt to retrieve the ID token, and may return an error if one is not found. If an ID token is found, then the connection logic may inquire with the closed loop network 120 whether the ID token is legitimate, or may consult one or more rules to determine for itself whether the ID token is legitimate.

If the answer at step 250 is “NO,” then processing may proceed to step 252, where the transaction may be terminated. Optionally, the connection logic may generate a fraud alert if an error was encountered and/or flag the transaction with the appropriate entities (including, but not limited to, the closed loop network, the purported requestor of the financial transaction, the purported recipient of the financial transaction, and any involved external networks). Processing may then proceed to step 254 and terminate.

If the answer at step 250 is “YES,” then processing may proceed to step 256 where it is determined whether the transaction message is encrypted according to an encryption protocol. If the answer at step 256 is “YES,” then processing may proceed to step 258 where the message may be decrypted.

At step 258, the encryption protocol used to encrypt the message may be identified based on the message, based on the originating closed loop network (e.g., when it is known that the closed loop network uses a particular encryption protocol), based on one or more rules available to the connection logic, or by querying the originator of the transaction message as to which encryption protocol was used. The connection logic may then decrypt the message according to the encryption protocol. Processing may then proceed to step 260. If it is determined at step 256 that the message is not encrypted, then processing may skip step 258 and proceed directly to step 260.

At step 260, the connection logic may determine whether the sender of the transaction request is authenticated with the connection protocol. For example, the closed loop ID token retrieved in step 250 may include an identifier of the sender's mobile device, a geolocation, and/or a personal pin. This information may be checked against known information about the sender. In some embodiments, this identifying information may be stored together as a “unique time stamped string” (UTSS). An exemplary embodiment of a UTSS is described in more detail with respect to FIG. 2C, below.

If it is determined at step 260 that the user is authenticated, then processing may proceed to step 262, where the connection may be established for a limited (potentially predefined) period of time. To this end, the connection logic may determine whether the predetermined period of time has elapsed at step 264 and, if so, may terminate the connection.

If the predetermined period of time has not elapsed, then the connection logic may, at step 266, share information between the closed loop network and the external network. For example, the connection logic may pass the transaction request to the external network, and may retrieve any requested information from the closed loop network and/or requestor on behalf of the external network.

At step 268, the connection logic may determine whether the closed loop network and the external network are done sharing information (e.g., the transaction has been completed). If so, then processing may proceed to step 252, where the connection may be terminated. If not, and there is still information to be shared, then processing may return to step 264 to determine whether any time remains for the connection. Once all information is shared or the time runs out, processing proceeds to step 252 where the connection is terminated.

At any point along the process shown in FIG. 2B, details of the connections session may be recorded for regulatory compliance (e.g., in anticipation of audits of financial transactions). In some embodiments, the records may be purged after a predetermined period of time.

Using the exemplary process of FIG. 2B, the connection logic may be capable of establishing a secure, authenticated connection. As noted above, the connection may be authenticated using a unique time stamped string (UTSS). FIG. 2C depicts an example of such a UTSS 280.

The UTSS 280 may include a time stamp 282 identifying the time at which the transaction message was generated. The timestamp 282 may be used to create dynamic UTSSes. For example, the time stamp may be used to randomize a number of digits included in certain fields of the UTSS.

The UTSS may further include device identifier information 284. The device identifier information 284 may identify the mobile device used to request the transaction. Examples of device identifier information 284 include a serial number of the mobile device, and the mobile device's International Mobile Station Equipment Identity (IMEI) number.

The UTSS 280 may include location information 286 identifying a location at which the mobile device was present when the transaction request was generated. For example, the location information 286 may include latitude and longitude coordinates. The location information 286 may be compared against known location information associated with the requestor to determine whether the request is likely to be legitimate (e.g., because it originated in a location frequented by the requestor) or illegitimate (e.g, because the request originated in a location remote from the requestor's typical location).

The UTSS 280 may further include an identifier 288 of a SIM card associated with the requestor's mobile device. For example, the UTSS 280 may identify the International Mobile Subscriber Identity (IMBI) number associated with the SIM card.

The UTSS 280 may also include a user identifier 290, such as a PIN number supplied by the user.

Taken together, the identifiers of the UTSS may provide a strong verification that the requestor is who they purport to be. The varied identifiers serve to validate the user's device, location, connection (via the SIM card), and user identity. Information in the UTSS may be collected from multiple sources, such as the requestor of the transaction, the mobile carrier of the requestor, the closed loop network, etc.

FIGS. 2A-2C describe an efficient and secure process for carrying out financial transactions. However, a user may not wish to use such a process, no matter how convenient, if the user perceives that the process may compromise their privacy.

Over 90% of transactions around the world are still initiated and carried out in cash-based currency form. Cash-based currency is used to exchange value between two or more parties in a jointly and often universally accepted method of value. Unless a paper record was created at the time of the exchange of cash, there is no written record of an exchange of value. As the market transitions to non-paper based forms of payment and exchange of value (e.g., electronic currency), many consumers want some of the same characteristics of cash based currencies, some of which relate to privacy and the confidential nature of the transaction. Existing transaction protocols may be unable to provide the requisite level of privacy protection.

An exemplary embodiment depicted in FIG. 3 addresses privacy concerns by purging eligible financial records after a predetermined period of time, thus replicating the privacy and confidentiality of paper based cash, while maintaining compliance with banking, treasury, and government related rules and regulations.

According to some embodiments, advance screening may be performed in order to determine that the individual requesting the ability to perform electronic cash transactions (and a type of account associated with the individual) would be legally eligible to use this service. Once the account and/or holder is deemed eligible, the individual may be offered the choice as to whether to sign up for the service.

Upon opting into the service and reviewing/accepting relevant rules and terms, then a mobile cash account may be activated for the individual. Each individual may be assigned a “cash limit” and maximum record retention limit based on, for example, the individual's credit score (or mobile credit score, described herein).

Once the user decides to initiate a transaction, at step 310 the transaction may be received by the connection logic. In order to initiate the transaction, the user may interact with a display, such as a graphical user interface (GUI) on a mobile device capable of connecting to the connection logic.

The GUI may provide options for indicating a desired amount of currency to be sent. The GUI may further provide an option for indicating a destination (e.g., another individual or account) to which the currency should be sent. For example, the destination may be identified based on an email address, a phone number, or an identifier associated with an electronic cash transaction account.

Optionally, the connection logic may respond to the user at step 312 by causing the user's mobile financial application to display a regulatory disclaimer relating to the purging of financial records. For example, the disclaimer may indicate that the user bears the responsibility of maintaining records in accordance with applicable law. The connection logic may then pass control of the transaction to the business and routing logic.

At step 314, the request may be sent to a second mobile device associated with the destination of the transaction, or an external network that services the transaction. The recipient may receive a notification of a cash transaction sent to an account associated with their email address, phone number, or account identify.

At step 316, the recipient may be provided with an option to accept or deny the request. For example, the recipient's mobile financial application may provide an option to confirm that funds associated with the transaction should be received or sent. If the recipient indicates, at step 316, that the request is not accepted, then processing may proceed to step 318 and terminate.

If, on the other hand, the recipient indicates at step 316 that the transaction should continue, then processing may proceed to step 320 where the transaction may be carried out. A record, such as a receipt, may be generated. In one embodiment, the receipt may be a “time expiring” receipt that appears in the original requestor's mobile financial application along with a notification that the receipt will automatically expire after a predetermined period of time (e.g., 30 seconds). The user may be presented with an option (step 322) to save the receipt before the predetermined period of time runs out. In some embodiments, the predetermined period of time may be set by the user, and the purge functionality may be toggled on or off.

Alternatively, the receipt may be automatically stored and an option may be provided, at step 322, for the user to purge the receipt.

If option is selected and the receipt is saved, then processing may proceed to step 324 and the receipt may be stored in a storage of the electronic device associated with the recipient. Alternatively, the receipt may be saved remotely (for example, in a central server). The requestor may have the option of placing a timer on the saved receipt so that the saved receipt is stored for a predetermined period of time (e.g., 1 week or 1 month).

If the recipient does not elect to opt-in to saving the receipt, then the receipt may expire in a predetermined period of time, such as 30 seconds.

In some embodiments, a user interface may be provided for determining how the transaction should be recorded, how long the information should be stored, and whether the requestor wants the electronic record permanently purged from the system (assuming no violation of regulatory requirements).

If the requestor indicates, at step 322, that the receipt should not be saved, then at step 326 the business and routing logic may issue instructions to any devices (including the original mobile device and the second mobile device) associated with the transaction. The instructions may instruct the devices to quarantine all records related to the electronic cash transfer. As a result, the records may be placed in an inaccessible location until they are either purged or removed from quarantine.

The records may be held in quarantine for a predetermined period of time and purged if and when it is determined to be appropriate to do so, for example based on characteristics of the accounts involved and/or the transfer itself. To this end, at step 328 one or more of the devices holding quarantined records may inspect a rules database to determine what actions to take with respect to the record activity of the parties to the transaction. The rules database may include regulatory rules for satisfying government or institutional regulatory requirements. The rules database may further include custom rules defined by the owner or administrator of the cash transaction network and/or the users of the cash transaction network.

If at step 328 it is determined that the records are not eligible for purging, then processing may return to step 324 where the transaction records may be copied to a transaction storage database. The transaction records may be flagged with a label indicating why the transaction records may not be purged. In one embodiment, a reporting FINCEN file may be generated and sent to the relevant authorities, such as the US treasury.

If, on the other hand, it is determined at step 328 that the records are eligible for purging, then at step 330 the business and routing logic may determine whether the predetermined period of time has elapsed. If the predetermined period of time has not elapsed, then the system may wait, at step 332, until the predetermined period of time has elapsed. Processing may then proceed to step 334, where all records associated with the transaction may be purged on all systems which took part in the transaction. Alternatively or in addition, records may be established on some systems (e.g., for regulatory purposes) but deleted from others.

After the records have been purged, no indication that the transaction has taken place may be existent (aside from the fact that the currency is no longer present in one account but is present in another). Thus, exemplary embodiments allow electronic currencies and/or mobile transactions to mimic the anonymity of cash transactions.

Once a connection is established according to the process described in FIGS. 2A-2C and 3, transaction messages may be routed between the closed loop and the external network. At the same time, other users in other networks may be attempting to establish connections through the connection logic and to external networks, which could easily become overwhelmed with the volume of traffic. With the plethora of connected devices and connected users existing online today, and the ease of conducting financial transactions anywhere anytime, either for direct money exchange or as payments for goods or services, a large number of unique financial transactions are currently generated and need to be processed. Given the current costs of processing a transaction, micropayments are managed differently from regular financial transactions, or avoided completely by certain financial service providers.

According to another exemplary embodiment, a process is provided for aggregating and promising transactions, and performing load balancing among transaction messages. Such a process is described with respect to FIG. 4.

At step 410, a transaction request message may be received at the connection logic. The connection logic may pass the request to the business and routing logic.

At step 412, the business and routing logic may parse the request message to identify elements of the message which the message may share in common with other messages. For example, the parsing may identify key words, message identifiers, a requestor or destination of the message, networks associated with the message, types of transactions (e.g., microtransactions), the Internet location (e.g., an IP address or other identifier) of the Sender, Sending Agent, Receiver and Receiving Agent, etc.

At step 414, the business and routing logic may, on the basis of the parsing performed at step 412, categorize the request according to the common features identified at step 412. Steps 410 and 412 may be performed for multiple messages and the messages may be grouped into similar categories.

At step 416, the Provider may aggregate requests based on commonalities identified in steps 412-414. For example, messages may be aggregated across multiple Senders or Sending Agents, and across multiple Receivers or Receiving Agents. The messages may (optionally) be collected into a single aggregated request that carries out multiple requested transactions as a single transaction.

At step 418, the aggregated requests may be analyzed based on one or more metrics. Examples of such metrics include, but are not limited to, business and network throughput considerations.

For example, for certain types of requests timing may be less important than for other types of requests. An application that requires authentication for the request to be carried out may be time-sensitive (since the authentication may expire), but an unauthenticated transaction may not be as time-sensitive. Transactions may also be flagged with types, and the metrics may prioritize certain types of transactions over others. For example, a user may wish that a transaction that represents a tip (e.g., to a door man, a valet, etc.), or a transaction that represents a donation to a disaster relief fund, to occur quickly. Alternatively, a transaction associated with a particular deadline may be flagged for faster processing.

The business and routing logic may further assign priorities based on certain metrics or categories (e.g., certain Senders and/or Sending Agents may receive priority over others). For example, a frequent user of a particular mobile wallet application might have their payments prioritized so that they are processed faster. In another example, large payments may be associated with a higher compliance and credit risk, so the payments may be prioritized based on the sender's credit score. A sender with a lower credit score might have their payment routed to a compliance officer, who might preapprove the sender and/or contact the sender directly.

The score may also be based on third-party scores. For example, eBay and Amazon maintain a set of ratings for their sellers which represent the seller's rating. The score calculated at step 418 may take these scores into account (e.g., so that a seller with a higher rating has their payments prioritized).

In exemplary embodiments, the business and routing logic may use a number-based priority scoring system (e.g., 0-100) to establish a priority score for the Senders and/or Sending Agents.

The transaction may involve processing by an intermediate exchange that handles the transaction requests. At step 420, the business and routing logic may modify the exchange based on the priorities assigned at step 418. For example, the business and routing logic may generate virtual entry and exit points into the exchange (e.g., tunnels) to facilitate more efficient transactions between the Sender, Sending Agent, Receiver and Receiving Agent. The Exchange may be augmented with appropriate store-and-forward capacity to reduce the effective distance between Senders and Receivers. In another embodiment, the exchange may be modified with business logic for managing priorities between various Senders and Receivers dynamically in real time.

At step 422, the business and routing logic may access a third party system associated with the aggregated transaction of step 416, and at step 424 may execute the aggregated transaction(s). The aggregated transaction may be executed as a single transaction or may be executed as a series of transactions which may be less than or equal to the number of transactions in the aggregated request.

Processing may then proceed to step 426 and terminate.

The exemplary embodiments described above may considerably reduce the cost of processing micropayments. Furthermore, anticipating a cost reduction in processing micropayments, exemplary embodiments may efficiently manage the high volume and high frequency of micropayments.

Exemplary embodiments may provide for the efficient and timely completion of micropayments in a high volume and high frequency environment, using optimization techniques and a technology architecture that allows for configurability. The delivery of an individual transaction or a group of transactions can therefore be efficiently, quickly, and/or deterministically managed.

Taken together, the above-described protocols allow mobile transactions to be carried out efficiently, effectively, and anonymously.

Some or all of the exemplary embodiments described herein may be embodied as instructions stored on one or more non-transitory computer-readable mediums. The instructions, when executed, may cause one or more processors to carry out the functionality described herein.

### Computer-Implemented Embodiments

Some or all of the exemplary embodiments described herein may be embodied as a method performed in an electronic device having a processor that carries out the steps of the method. Furthermore, some or all of the exemplary embodiments described herein may be embodied as a system including a memory for storing instructions and a processor that is configured to execute the instructions in order to carry out the functionality described herein.

Still further, one or more of the acts described herein may be encoded as computer-executable instructions executable by processing logic. The computer-executable instructions may be stored on one or more non-transitory computer readable media. One or more of the above acts described herein may be performed in a suitably-programmed electronic device.

An exemplary electronic device 500 is depicted in FIG. 5. The electronic device 500 may take many forms, including but not limited to a computer, workstation, server, network computer, quantum computer, optical computer, Internet appliance, mobile device, a pager, a tablet computer, a smart sensor, application specific processing device, etc.

The electronic device 500 described herein is illustrative and may take other forms. For example, an alternative implementation of the electronic device may have fewer components, more components, or components that are in a configuration that differs from the configuration described below. The components described below may be implemented using hardware based logic, software based logic and/or logic that is a combination of hardware and software based logic (e.g., hybrid logic); therefore, components described herein are not limited to a specific type of logic.

The electronic device 500 may include a processor 502. The processor 502 may include hardware based logic or a combination of hardware based logic and software to execute instructions on behalf of the electronic device 500. The processor 502 may include one or more cores 503 that execute instructions on behalf of the processor 502. The processor 502 may include logic that may interpret, execute, and/or otherwise process information contained in, for example, a memory 504. The information may include computer-executable instructions and/or data that may implement one or more embodiments of the invention. The processor 502 may comprise a variety of homogeneous or heterogeneous hardware. The hardware may include, for example, some combination of one or more processors, microprocessors, field programmable gate arrays (FPGAs), application specific instruction set processors (ASIPs), application specific integrated circuits (ASICs), complex programmable logic devices (CPLDs), graphics processing units (GPUs), or other types of processing logic that may interpret, execute, manipulate, and/or otherwise process the information. The processor 502 may include a single core or multiple cores. Moreover, the processor may include a system-on-chip (SoC) or system-in-package (SiP).

The electronic device 500 may include a memory 504, which may be embodied as one or more tangible non-transitory computer-readable storage media for storing one or more computer-executable instructions or software that may implement one or more embodiments of the invention. The memory 504 may comprise a RAM that may include RAM devices that may store the information. The RAM devices may be volatile or non-volatile and may include, for example, one or more DRAM devices, flash memory devices, SRAM devices, zero-capacitor RAM (ZRAM) devices, twin transistor RAM (TTRAM) devices, read-only memory (ROM) devices, ferroelectric RAM (FeRAM) devices, magneto-resistive RAM (MRAM) devices, phase change memory RAM (PRAM) devices, or other types of RAM devices.

The electronic device 500 may include a virtual machine (VM) 505 for executing the instructions loaded in the memory 504. A virtual machine 505 may be provided to handle a process running on multiple processors 502 so that the process 502 may appear to be using only one computing resource rather than multiple computing resources. Virtualization may be employed in the electronic device 500 so that infrastructure and resources in the electronic device 500 may be shared dynamically. Multiple VMs 505 may be resident on a single electronic device 500.

A hardware accelerator, 506 may be implemented in an ASIC, FPGA, or some other device. The hardware accelerator 506 may be used to reduce the general processing time of the electronic device 500.

The electronic device 500 may include a network interface 508 to interface to a Local Area Network (LAN), Wide Area Network (WAN) or the Internet through a variety of connections including, but not limited to, standard telephone lines, LAN or WAN links (e.g., T1, T3, 56 kb, X.25), broadband connections (e.g., integrated services digital network (ISDN), Frame Relay, asynchronous transfer mode (ATM), wireless connections (e.g., 802.11), high-speed interconnects (e.g., InfiniBand, gigabit Ethernet, Myrinet) or some combination of any or all of the above. The network interface 508 may include a built-in network adapter, network interface card, personal computer memory card international association (PCMCIA) network card, card bus network adapter, wireless network adapter, universal serial bus (USB) network adapter, modem or any other device suitable for interfacing the electronic device to any type of network capable of communication and performing the operations described herein.

The electronic device 500 may include one or more input devices 510, such as a keyboard, a multi-point touch interface, a pointing device (e.g., a mouse), a gyroscope, an accelerometer, a haptic device, a tactile device, a neural device, a microphone, or a camera that may be used to receive input from, for example, a user. Note that electronic device 500 may include other suitable I/O peripherals.

The input devices 510 may allow a user to provide input that is registered on a visual display device 514. A graphical user interface (GUI) 516 may be shown on the display device 514.

A storage device 518 may also be associated with the electronic device 500. The storage device 518 may be accessible to the processor 502 via an I/O bus. Information stored in the storage 518 may be executed, interpreted, manipulated, and/or otherwise processed by the processor. The storage device 518 may include, for example, a magnetic disk, optical disk (e.g., CD-ROM, DVD player), random-access memory (RAM) disk, tape unit, and/or flash drive. The information may be stored on one or more non-transient tangible computer-readable media contained in the storage device. This media may include, for example, magnetic discs, optical discs, magnetic tape, and/or memory devices (e.g., flash memory devices, static RAM (SRAM) devices, dynamic RAM (DRAM) devices, or other memory devices). The information may include data and/or computer-executable instructions that may implement one or more embodiments of the invention

The storage device 518 may further store files 420, applications 522, and the electronic device 500 can be running an operating system (OS) 524. Examples of OS may include the Microsoft® Windows® operating systems, the Unix and Linux operating systems, the MacOS® for Macintosh computers, an embedded operating system, such as the Symbian OS, a real-time operating system, an open source operating system, a proprietary operating system, operating systems for mobile electronic devices, or other operating system capable of running on the electronic device 500 and performing the operations described herein. The operating system 524 may be running in native mode or emulated mode.

The storage device may further store logic for implementing the connection logic 130, the routing and business logic 140, the logic for establishing the secure connection 214, load balancing logic 526, purging logic 528, and any other logic suitable for carrying out the procedures described in the present application.

The foregoing description may provide illustration and description of various embodiments of the invention, but is not intended to be exhaustive or to limit the invention to the precise form disclosed. Modifications and variations may be possible in light of the above teachings or may be acquired from practice of the invention. For example, while a series of acts has been described above, the order of the acts may be modified in other implementations consistent with the principles of the invention. Further, non-dependent acts may be performed in parallel.

In addition, one or more implementations consistent with principles of the invention may be implemented using one or more devices and/or configurations other than those illustrated in the Figures and described in the Specification without departing from the spirit of the invention. One or more devices and/or components may be added and/or removed from the implementations of the figures depending on specific deployments and/or applications. Also, one or more disclosed implementations may not be limited to a specific combination of hardware.

Furthermore, certain portions of the invention may be implemented as logic that may perform one or more functions. This logic may include hardware, such as hardwired logic, an application-specific integrated circuit, a field programmable gate array, a microprocessor, software, or a combination of hardware and software.

1. A system for routing mobile transaction messages, the system comprising:
a receiving interface for receiving a request to perform a mobile transaction from a requestor in a closed-loop network, wherein the request relates to an entity in an external network and the receiving interface is connected to the closed-loop network and configured to receive transaction messages in a format compatible with the closed-loop network;
a non-transitory electronic-device readable storage medium storing electronic instructions that, when executed by a processor of the system, cause the processor to:
parse the request to identify a type of the request,
identify further information needed to carry out requests of the identified type,
retrieve the identified further information,
evaluate the retrieved identified further information to determine whether the mobile transaction is permitted to proceed, and
generate instructions instructing an external network to carry out the request when the system determines that the mobile transaction is permitted to proceed; and
a transmitting interface for transmitting the instructions, wherein the transmitting interface is connected to the external network and configured to transmit transaction messages in a format compatible with the external network.

2. The system of claim 1, wherein the instructions further comprise instructions causing the processor to:
inspect a unique time stamped string associated with the request, wherein the unique time stamped string comprises a time stamp, identifying information related to a mobile device of the requestor, and an identity of the requestor.

3. The system of claim 2, wherein the unique time stamped string further comprises location information identifying a location of the mobile device of the requestor or a SIM identifier identifying a SIM card of the mobile device of the requestor.

4. The system of claim 1, wherein the type of the request is selected from the group comprising a balance inquiry, a request to transfer funds, and a request for authentication.

5. The system of claim 1, wherein the request is a request to transfer an electronic currency.

6. The system of claim 5, wherein the request to transfer the electronic currency is a request to transfer the electronic currency from an external entity, and the external entity is a bank or currency account.

7. The system of claim 5, wherein the request originates at a mobile wallet application, and the request to transfer the electronic currency is a request to transfer the electronic currency from another user of the mobile wallet application.

8. The system of claim 1, further comprising:
generating a record of the transaction at a mobile device of the requestor and an entity involved in the transaction;
receiving an instruction from the requestor not to store a receipt for the transaction;
waiting a predetermined period of time; and
purging the record of the transaction from the mobile device of the requestor and from the entity.

9. The system of claim 8, wherein the predetermined period of time is determined, at least in part, based on regulatory compliance requirements.

10. The system of claim 1, further comprising:
receiving a plurality of requests associated with a plurality of transactions;
determining that a subset of the plurality of requests are of a same type;
aggregating the subset of the plurality of requests; and
executing an aggregated transaction based on the plurality of transactions.

11. The system of claim 10, further comprising:
assigning a priority to the subset of the plurality of requests; and
executing the aggregated transaction based on the priority.

12. A computer-implemented method comprising:
receiving, at a receiving interface of an electronic device, a request to execute a transaction by a requestor;
identifying, using a processor of the electronic device, a recipient of the request;
transmitting, at a transmitting interface of the electronic device, the request to execute the transaction, the request transmitted to the recipient of the request;
receiving, at the receiving interface, an affirmation that the transaction should be performed;
generating a record of the transaction;
storing the record in a non-transitory electronic-device readable medium associated with the requestor; and
either purging the record after a predetermined period of time, or determining that the record is not eligible to be purged.

13. The method of claim 12, further comprising:
receiving an instruction not to save the record of the transaction;
quarantining the record of the transaction in a quarantine, wherein the record is inaccessible while in the quarantine;
consulting purge eligibility logic to determine whether the record is eligible for purging; and
purging the record from the quarantine only if the purge eligibility logic indicates that the record is eligible for purging.

14. The method of claim 13, wherein the purge eligibility logic is programmed with one or more regulatory rules that reflect a legal requirement that the record be maintained for a regulatory period of time, and the predetermined period of time is selected based at least in part on the regulatory period of time.

15. The method of claim 12, further comprising:
receiving an instruction not to save the record of the transaction;
quarantining the record of the transaction in a quarantine, wherein the record is inaccessible while in the quarantine;
consulting purge eligibility logic to determine whether the record is eligible for purging; and
refraining from purging the record from the quarantine if the purge eligibility logic indicates that the record is not eligible for purging.

16. The method of claim 12, further comprising:
storing a copy of the record of the transaction on a non-transitory electronic device readable storage medium associated with at least one of the recipient of the request or an intermediate entity involved in processing the request; and
purging the copy of the record after a second predetermined period of time.

17. A non-transitory electronic device readable storage medium storing instructions that, when executed by a processor, cause the processor to:
receive a plurality of requests to perform a plurality of mobile transactions from a plurality of requestors, wherein one or more of the requests relate to an entity in an external network;
determine that a subset of the plurality of requests are related;
aggregate the subset into an aggregated request;
connecting to the entity in the external network; and
executing the aggregated request with the entity as a single transaction.

18. The medium of claim 17, further comprising assigning a priority to the aggregated request, and executing the aggregated request in an order based on the assigned priority.

19. The medium of claim 17, wherein the requestor interfaces with the entity in the external network via an electronic exchange, and wherein connecting to the entity in the external network comprises:
generating one or more entry or exit points into or out of the exchange to facilitate a connection between the requestor and the entity in the external network.

20. The medium of claim 17, wherein the requestor is associated with a closed-loop network and the external network comprises a third party system external to the closed-loop network.
